(19) United States
(12) Patent Application Publication
(10) Pub. No.: US 2009/0139525 A1
(43) Pub. Date: Jun. 4, 2009

(54) COMFORT LINER FOR PRESSURE FACE MASKS AND NASAL MASKS

(76) Inventor: Louis Schirm, Temecula, CA (US)

Correspondence Address: MICHAEL A. SHIPPEY, PH. D., 4506 S. La Palma Avenue, Anaheim, CA, 92807, US

(21) Appl. No.: 11/948,695

(22) Filed: Nov. 30, 2007

(51) Int. Cl. A62B 18/02

(52) U.S. Cl. 128/205.25; 128/206.21

(57) ABSTRACT

Disclosed is a device and method for improving the facial comfort and sealing ability of a full-face mask comprising a liner of soft material, preferably made from moleskin or the like. The disclosed face mask liner provides a superior feel to the user's face compared with standard face masks with air-filled cushion or silicone gasket cuffs, while providing a more comfortable user experience and a superior seal to prevent loss of breathing gas. Also disclosed is a similar device and method for improving the facial comfort of a nasal mask, providing a mask that is more comfortable to the user.

### RELATED APPLICATION

This application is an original U.S. patent application.

### BACKGROUND OF THE INVENTION

1. Technical Field of the Invention

The present application relates generally to after-market adapters for face masks and, more particularly, to adapters for positive pressure full-face masks and nasal masks resulting in reduced irritation to the face of the user.

2. Description of the Related Art

Constant positive air pressure (CPAP) masks are used to provide a breathable mixture of gases, typically air, provided at above ambient pressure to a user. A CPAP mask forms a seal around the nose (and mouth, in some masks) of a user's face, providing an interface between the air source and the user's respiratory system that is ideally free of leaks. CPAP masks are used in a variety of medical treatment procedures. Positive pressure full-face masks are also used in other applications, for example, in breathing apparatus used by fire fighters, aircraft pilots, miners, divers, and others in similar occupations. Full face masks are also used as industrial safety and bacterial/viral filtration masks.

A CPAP mask comprises a dome and a cuff, which forms a seal around the user's face. The dome fits over the user's nose and mouth, and provides a conduit to the source of air. Ideally, the seal is air-tight under the pressures in normal service. Typically, cuffs in CPAP masks comprise silicone gaskets, and other materials with similar properties of high elasticity.

A problem which the cuffs in CPAP masks often lead to is irritation around the face of the user. This is particularly found (though not limited to) in medical environments, where the mask may be worn for hours or days without changing or removing from the face. This occurs because silicone gaskets often do not seal well to the user's face, especially around the bridge and lower sides of the nose. The resulting air leaks into the user's eyes, causing eye irritation. The combination of skin and eye irritation reduces user tolerance and compliance with the medical procedure utilizing the mask.

CPAP masks often will not acceptably seal to a face with wrinkles or other irregularities, as is often found in older persons that commonly employ CPAP procedures. The relatively high velocity, positive pressure air creates a chilling effect when it leaks out of the mask at the interface with the surface of the skin. This creates a great deal of discomfort in some patients. Extended use of a plastic mask against bare skin may lead to a latex-induced rash, or even blistering. This is yet another source of discomfort in existing masks.

Another type of facemask is a nasal mask. Nasal masks provide air to the user's nose only. Nasal masks are typically used in continuous positive airway pressure (CPP) therapy for sleep apnea. Because a nasal mask is worn overnight, every night, mask discomfort is a major factor in noncompliance with CPP therapy. Skin irritation at the interface between the mask and the face is common. Air leaking into the user's eyes also registers complaints. The interface between the mask and the skin of the user in a nasal mask is typically the same type of cuff silicone as in a CPAP full face mask.

Other types of masks are known in the art, such as facemasks made of hydrogels. These masks require complex adjustment prior to use. Even these masks suffer from air leakage, especially into the eyes, and skin irritation. These are problems for both full-face masks and nasal masks, both in short term and in long term applications. These problems often lead to the problems of discomfort and discontinuation of the therapy.

In addition to discomfort, CPAP masks often have a limited lifetime. These can wear out after 6 months of constant use. This is an additional expense on often limited-income patients.

Workers in the industry are developing improved face mask designs to overcome these problems. However, the improved masks will take time to reach the marketplace. Also, they may involve increased expense, as is often the case with state of the art medical equipment. The use of plastic in mask construction, which can lead to skin irritation and rashes, continues unabated in these modern masks. Furthermore, there is a large inventory of full face and nasal masks in the market today, of the type that can lead to the problems described above. Accordingly, there is a need to find a retrofit for existing CPAP masks in order to improve the seal, increase the life of the mask, and reduce discomfort to the user.

In this document, the term ‘breathing mask’ is used as a generic term to cover all masks that are used to assist people in breathing. The term includes full face masks, nasal masks, SCUBA masks, and other masks that are used in the delivery of air or other breathable gas to humans.

### SUMMARY OF THE INVENTION

A first embodiment of the present invention provides a soft liner for the cuff of a full-face or nasal mask. Preferably, the liner is made from natural or natural-like material. More preferably, the liner is comprised of a material like Dr. Scholl's Moleskin®. Cotton based materials like terrycloth are also excellent materials of composition for use in the present invention.

A second embodiment provides an adhesive backing to the soft liner, for attaching to the cuff of a full-face or nasal mask.

A third embodiment provides a liner that is removable, that is washable, and that is reusable.

A fourth embodiment provides a liner that is closely conformable to a human face, thereby reducing air leaks around the face and reducing resultant ski irritation.

A fifth embodiment provides a forehead pad to attach to a full face mask in a similar manner as the liner.

The disclosed liner is suitable for retro-fit of existing full face and nasal masks. It is user-installable, washable, and reusable. It is capable of extending the lifetime of a mask by a significant margin.

### BRIEF DESCRIPTION OF THE FIGURES

FIG. 1 illustrates a preferred embodiment of the disclosed mask liner, mounted on a mask.

FIG. 2 displays the liner of the current invention with associated forehead pad, again mounted on a mask.

FIG. 3 is a diagram of a portion of a human face and equivalent portion of a mask, with no liner installed.

FIG. 4 is a diagram of the same portion of a human face and equivalent portion of a mask as in FIG. 3, this time with the liner of the current invention installed.

Other objects and advantages of the present invention will become apparent from the following descriptions, taken in connection with the accompanying drawings, wherein, by way of illustration and example, an embodiment of the present invention is disclosed.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

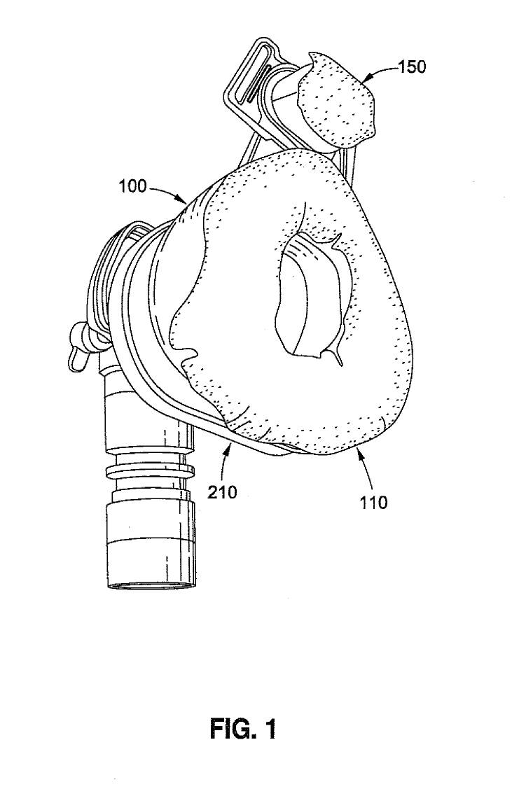

Referring to FIG. 1, a preferred embodiment of the disclosed invention 100 comprises a liner 110, attached over a cuff 210 of a breathing mask 200. The cuff 210 forms the part of the breathing mask that would normally contact the face of the user, if the current invention 100 was not installed on the mask. Breathing mask and cuff are not a part of the claimed invention.

The liner 110 is preferably contoured to approximate the contours of a human face, as shown in FIG. 1. The width of the liner 110 may vary along the circumference of the cuff 210, depending on the thickness and width of the cuff 210, or on other considerations.

The liner 110 is comprised of a soft material that is non-irritable to human skin. When the mask is worn, the liner 110 is the only material that touches the face of the user. Other than straps around the head, no portion of the mask proper will come into contact with the body of the user, when the current invention is employed. Preferably, the material comprises a vertical nap. By this, we mean a soft material that has a relatively long nap that is oriented perpendicularly to the surface of the material. Moleskin® and cotton are popular examples of soft materials possessing vertical nap that are suitable for use in the liner of the present invention.

Because breathing masks, and particularly the cuff portions, can contain latex, they are often responsible for latex-induced skin rash in mask users. A principal feature of the current invention is that it will reduce this type of rash by insulating the user from the source of latex in the breathing mask.

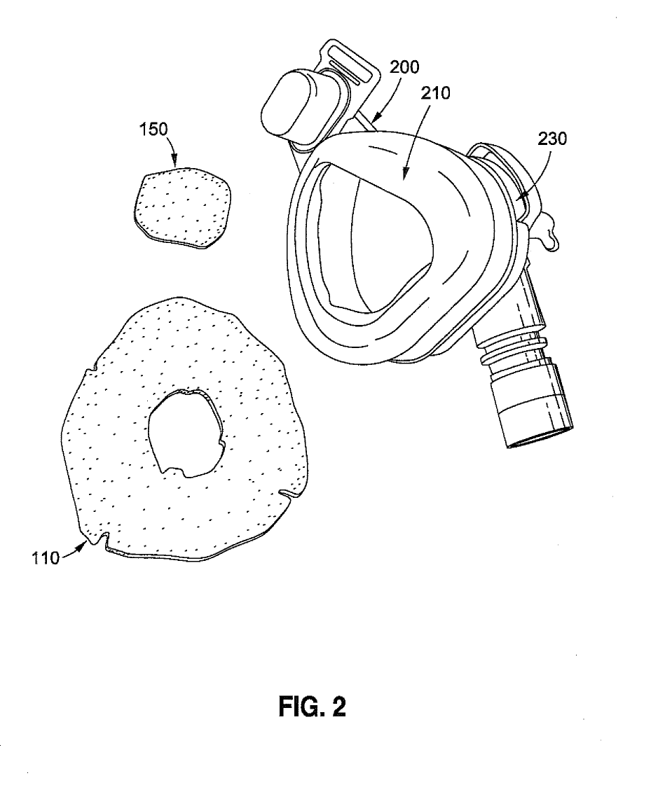

Another preferred embodiment of the current invention is shown in FIG. 2. Here, invention 100 comprises two components. The first component, liner 110, is the familiar facial interface liner seen in FIG. 1. The second component is forehead pad 150. This is comprised of the same material as liner 110. Pad 150 shields the forehead of the user from direct facial contact with the breathing mask.

Both liner 110 and pad 150 are preferably completely compatible with air, and with any other breathable gas mixture that may be employed. Both are preferably attachable to a breathing mask, and detachable from the mask, simply and easily by a mask user. Both liner 110 and pad 150 are preferably washable by ordinary washing means, so that they can be reused on a mask repeatedly, while being kept clean.

Preferably, both liner 110 and pad 150 are comprised of a soft, washable material. Cotton-based materials like terrycloth are found to be excellent materials for this use. Dr. Scholl's Moleskin® is also found to work well in the present invention.

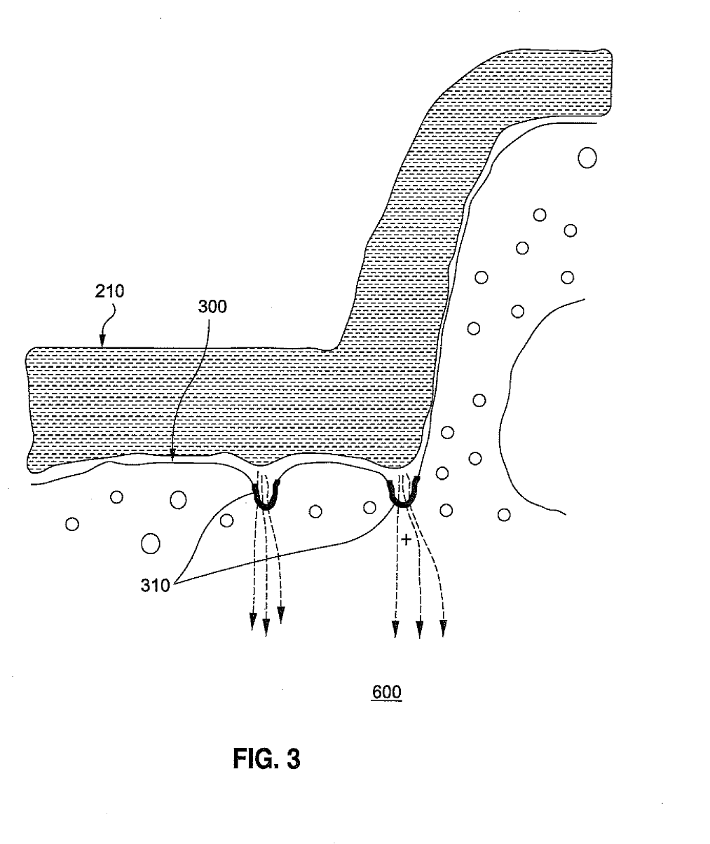

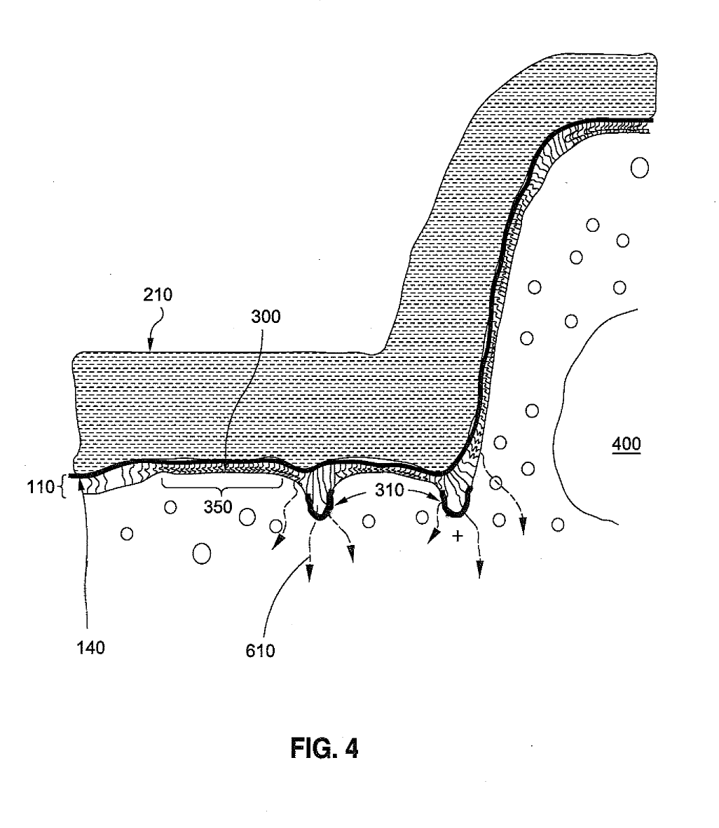

The next two figures, FIG. 3 and FIG. 4, illustrate a current working hypothesis to explain the performance in reducing skin irritation as exhibited by use of the current invention. It will be understood that the claims herein are not modified or limited in any way by the correctness of this working hypothesis. It is offered as a means to appreciate part of the utility of the current invention.

FIG. 3 illustrates in cross section a portion of the face of a mask user, wearing the mask, in the absence of the liner of the current invention. The right nostril is seen as 400. The identifier 300 denotes the facial skin in contact with the breathing mask. The portion of the breathing mask displayed is a part of the cuff 210, which is in contact with the face.

What can be seen in FIG. 3 is that the cuff 210 at a greatly magnified level is not in close conformity with facial skin 300 at every point. Not unexpectedly, the contact varies most appreciably at the presence of facial wrinkles, denoted as 310.

Often times, air leaks into the interface between facial skin 300 and mask cuff 210. As this air 600, exits the mask, it does so at high velocity due to the narrow exit opening. Not surprisingly, the biggest such leaks are found at facial wrinkles 310. There the high velocity air expands, and cools, as gases do when expanding. This high velocity air expansion is thought to have several deleterious effects. It leads to user discomfort, and contributes to skin irritation. In fact, this effect can, over time, feel akin to frostbite. The expanding gas may erode the surface of the cuff as well, leading to deterioration of the breathing mask. This deterioration typically leads to recommendation of expensive mask replacement every six months, adding to the high expense of the medical treatment regime.

Contrast this scenario to the view in FIG. 4. Here, the same portion of a breathing mask user's face, and the cuff of the mask, is shown as seen previously in FIG. 3. In this view, the current invention is installed on the mask. A portion of liner 110 is displayed in magnification. Of particular interest are the naturally occurring fibers 190 on the surface of liner 110. These are compressed and bent back in areas of close conformance of the mask cuff 210 to facial skin 300. Such an area is found in the section marked by 350.

Where the current invention has a big effect is at wrinkles 310. Here, the space created by the wrinkles is filled, at least partially, with the elongated, uncompressed fibers 190. These fibers occlude the dead space and inhibit the flow of air, so that the rapid expansion and resultant cooling effect is diminished or completely inhibited. Thus, the skin irritation is correspondingly reduced, as is the erosive effect on the cuff 210.

In fact, the erosive effect on cuff 210 is virtually eliminated by the insulative effect of liner 310. If any wind-caused erosion does take place, it will be borne by the inexpensive and replaceable liner, not the expensive mask. The mask thus has a much greater life span, since damage to the cuff is greatly reduced. Furthermore, the liner reduces pressure on critical joints of the mask, while maintaining an improved seal. This feature also leads to greater life span of the mask.

The efficacy of the liner 310 does depend to some degree on its close conformance with the facial skin and with the cuff portion of the mask. This conformance can often be enhanced by installing lateral slits or darts in the liner 310, especially at angles in the mask. These slits allow the liner to be more closely conformed to the cuff portion 210 of the breathing mask. Suitably contouring the cuff to achieve these purposes is within the scope of the skilled artisan without excessive experimentation.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A liner for a breathing mask, comprising:
a soft liner attachable to the cuff of a mask, and,
attachment means for said attachment,
wherein the soft liner is configured to contact a user's face during use.

2. The liner of claim 1, wherein the liner forms the interface between the mask and a user's face.

3. The liner of claim 1, wherein the liner comprises a material made from cotton.

4. The liner of claim 1, wherein the liner is removably attached to the mask.

5. The liner of claim 1, additionally comprising an adhesive backing for attaching the liner to the cuff of a mask.

6. The liner of claim 1, wherein the liner is removable from the mask, and replaceable with a new liner.

7. The liner of claim 1, wherein the liner is washable and reusable.

8. The liner of claim 1, wherein the liner further comprises a portion for contacting the forehead of the user.

9. The liner of claim 1, wherein the liner contains a plurality of slits, allowing the liner to be closely conformable to a human face.

10. The liner of claim 1, wherein the liner is comprised of hypoallergenic material.

11. The liner of claim 1, wherein the liner is comprised of material that does not tend to cause facial irritation.

12. The liner of claim 1, wherein the liner is comprised of material that has a vertical nap.

13. A liner for a breathing mask, comprising:
a washable and reusable soft liner, comprising a first portion attachable to the cuff of a mask,
a second portion attachable to the forehead portion of the mask;
and attachment means for said attachable portions,
wherein the soft liner is configured to conform to the contours of a user's face during use.
